(19) United States
(12) Patent Application Publication
(10) Pub. No.: US 2014/0300551 A1
(43) Pub. Date: Oct. 9, 2014

(54) INPUT ASSEMBLY FOR A KEYBOARD

(71) Applicant: Dale McPhee PURCOCKS, Gwent (GB)

(72) Inventor: Dale McPhee Purcocks, Gwent (GB)

(21) Appl. No.: 14/354,095

(22) PCT Filed: Oct. 24, 2012
(86) PCT No.: PCT/GB2012/052643

§ 371 Date: Apr. 24, 2014

(30) Foreign Application Priority Data
Oct. 24, 2011 (GB) 1118294.6

(51) Int. Cl. G06F 3/02; H01H 13/702; H01H 13/86

(52) U.S. Cl. CPC G06F 3/0202; H01H 13/86; H01H 13/702; H01H 2223/002
USPC 345/168

(57) ABSTRACT

An input assembly (1) for a human interface device such as a keyboard comprises a first membrane (20) having an electrical circuit provided on a surface thereof, and a second membrane (22) having electrical circuit provided on a surface thereof. The first (20) and second (22) membranes are arranged such that the electrical circuits of each membrane are facing each other. The assembly further includes a spacer member (24) provided between the first (20) and second (22) membranes configured to permit selective electrical connection between the electrical circuits of the first (20) and second (22) membranes. An electrical circuit board (50) is connected to the electrical circuits of the first (20) and second (22) membranes inwardly of the peripheral edges of both the first (20) and second (22) membranes, and a housing (70) is provided for enclosing and sealing the electrical circuit board (50). The housing (70) comprises an opening configured to receive the electrical circuit board. The edge of the opening defines an opening perimeter which is sealed to the outer surface of the first membrane (20) to seal and enclose the electrical circuit board (50).

The present invention relates to an input assembly for a human interface device and in particular to a waterproof input assembly for a keyboard.

Keyboards provide an interface between a computer and a user, with the user providing input commands to the computer via the keyboard. A computer keyboard essentially comprises a series of switches connected to a microprocessor that monitors the state of each switch and initiates a specific response to a change in that state.

Typically, the switch circuitry is provided by an input circuit unit formed from a sandwich of membranes, with upper and lower membranes having printed circuits on their facing surfaces, spaced by a further membrane which allows contact between the upper and lower circuits when the upper membrane is engaged by one of the keyboard keys.

The ability of keyboards to be impervious to liquids entering or contacting the keyboard is becoming increasingly important with the use of externally located keyboards in applications such as information kiosks or public internet access points increases which are exposed to the rainfall, and also more easily become dirty and therefore require cleaning. In addition, there is a need in environments such as hospitals for keyboards to be washable to enable them to be frequently sterilized. A waterproof keyboard is also extremely desirable in laptop applications, where liquid spilt onto the keyboard can not only damage the keyboard, but also the internal circuitry of the laptop causing serious damage.

In an attempt to provide a waterproof dome switch keyboard, several arrangements have been proposed. For example, in the arrangement described in U.S. Pat. No. 6,542,355 the input circuit unit is sandwiched and sealed between an elastomeric sheet and a further base membrane. Such an arrangement requires additional components and additional assembly steps, thereby increasing manufacturing time and cost. In addition, positioning an elastomeric sheet between the keys and the input circuit unit impedes the ability of the keys to contact the input circuit unit and delays contact time.

In other arrangements the upper and lower membranes are sealed around their periphery to form a sealed input circuit unit. However, the electrical contacts for connection of the input circuit unit to external components, and the components themselves must also be waterproofed, requiring for example further waterproof component casings. This again increases the number of components and assembly complexity, as well as increasing the bulk volume of the keyboard components.

In US2009/0262492 an enclosure is provided which entirely encloses and encapsulates the PCB of a keyboard assembly. The enclosure for the PCB is a two part housing which utilises silicon seals to seal the PCB within the enclosure.

It is therefore desirable to provide an improved input assembly for a keyboard which addresses the above described problems and/or which offers improvements generally.

According to the present invention there is provided a input assembly for a human interface device as described in the accompanying claims.

In an embodiment of the invention there is provided an input assembly for a human interface device such as a keyboard; the input assembly comprising a first membrane having an electrical circuit provided on a surface thereof; a second membrane having electrical circuit provided on a surface thereof, the first and second membranes being arranged such that the electrical circuits of each membrane are facing each other; a spacer member provided between the first and second membranes configured to permit selective electrical connection between the electrical circuits of the first and second membranes; an electrical circuit board connected to the electrical circuits of the first and second membranes inwardly of the peripheral edges of both the first and second membranes; and a housing for enclosing and sealing the electrical circuit board. The housing comprises an opening configured to receive the electrical circuit board, the edge of the opening defining an opening perimeter which is sealed to the outer surface of the first membrane to seal and enclose the electrical circuit board. As such, the input circuits of the first and second membranes and the PCB are combined in a single sealed input unit which can be installed into any keyboard without the requirement for any further waterproofing measures, and without the requirement to seal the input assembly to the body of the keyboard in a waterproof manner thereby providing a universal waterproof input assembly which simplifies keyboard assembly and reduces manufacturing costs. This is in contrast to waterproof keyboards of the prior art in which the input assemblies are sealed to the keyboard casing itself in a more complex manner.

The first and second membranes each include an electrical connection portion which are located inwardly of the peripheral edge of each membrane and are aligned and connected to each other through a corresponding aperture in the spacer membrane, and the electrical connectors are located between the electrical circuit board and a portion of the housing and the electrical circuit board is connected to the housing such that the electrical connectors of the first and second membranes are clamped between the electrical circuit board and the housing in electrical connection with the electrical circuit board. Clamping the input connectors in this manner between the electrical circuit board ensures a secure electrical and physical connection between the electrical connectors and the electrical circuit board. The electrical circuit board is preferably a printed circuit board (PCB).

The input assembly may further comprise a base member, the second membrane including a sealing portion defined about the peripheral edge of its outer surface which is sealed to the base member such that the electrical connectors and electrical circuit board are sealed from above by the housing and from below through the sealed connection between the second membrane and the base. The base member is preferably a rigid planar member which adds stiffness to the input assembly makes the input assembly easier to mount within the casing of a keyboard and maintains the nodes circuits of the upper and lower circuits in a rigidly fixed position for alignment with the keys of a keyboard. The support member is preferably a metal support plate, and forms part of the sealed input assembly.

The peripheral edges of the inner surfaces of the first and second membranes are sealed to one of the spacer membrane or each other. Preferably the first membrane defines an upper membrane having a sealing surface formed about the periphery of its lower surface which seals to the upper surface o the spacer membrane, and the second membrane defines a lower membrane having a sealing surface about the periphery of its upper surface which seals to the lower surface of the spacer membrane such that the first and second circuits are sealed and encapsulated within the input assembly within the perimeter defined by the sealing surfaces.

The housing preferably includes a plurality of internal ribs defining a clamping surface against which the electrical connectors of the first and second membranes are clamped by the electrical circuit board. In addition to providing a clamping surface the ribs locate the circuit board within the housing such that its outer surface is flush with the opening. As such the base of the housing defined in part by the circuit board when so connected is flush with the base of the second membrane such that input assembly is able sit flat and flush on the base of a keyboard assembly.

The housing may include at least one internal connection portion comprising a threaded bore configured to receive a corresponding at least one screw to secure the electrical circuit board to the housing, the at least one connection portion being arranged such that when the electrical circuit board is screwed thereto the electrical circuit board is urged into clamping engagement against the ribs of the housing to clamp the electrical connectors therebetween. Preferably the connection portion is at least two spigots extending downwardly from the inner surface of the top wall and having a threaded bore.

The housing comprises a flange section extending around and defining the opening, the flange section comprising a sealing surface which is adhered to the outer surface of the first membrane to seal the housing to the first membrane. The flange section provides an increased surface area to improve adhesion to the first membrane.

The housing preferably comprises a connection aperture configured to receive a connection cable for external electrical connection to the electrical circuit board and a sealing member or providing a seal between the cable and the portion of the housing defining the aperture.

The present invention will now be described by way of example only with reference to the following illustrative figures in which:

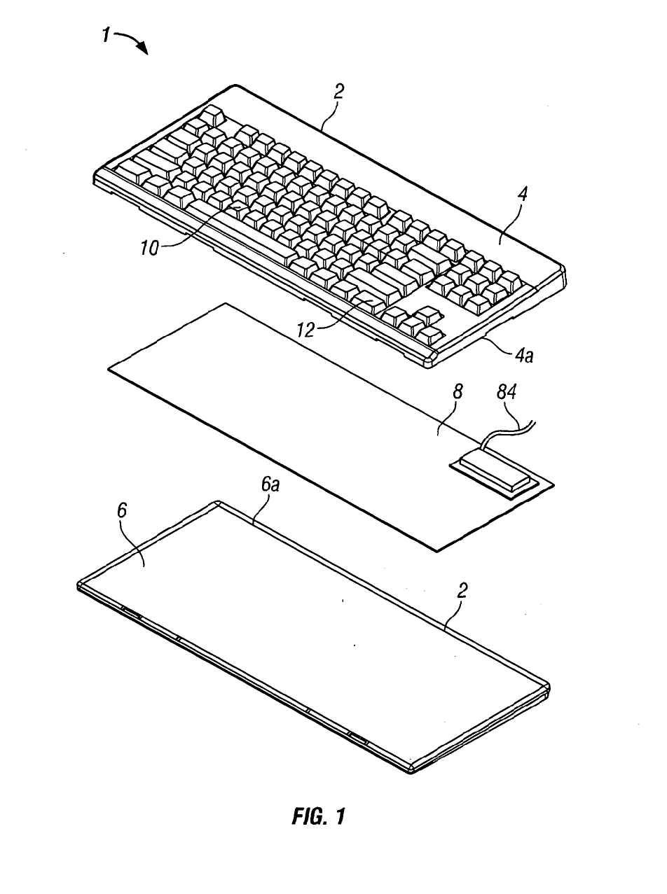

FIG. 1 shows an exploded view of a keyboard assembly according to an embodiment of the present invention;

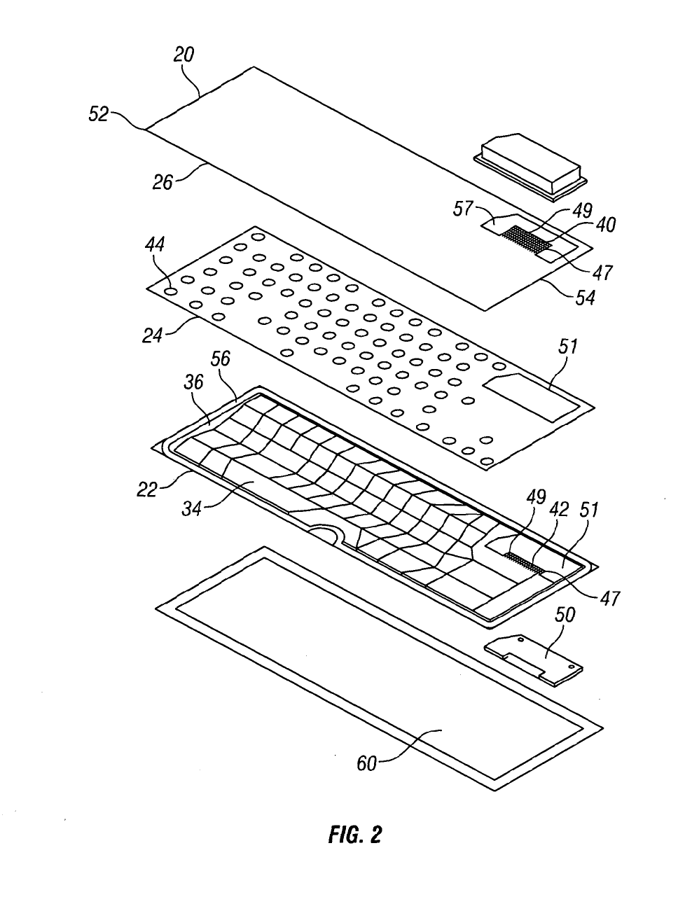

FIG. 2 shows an exploded view of the membrane assembly of the keyboard of FIG. 1;

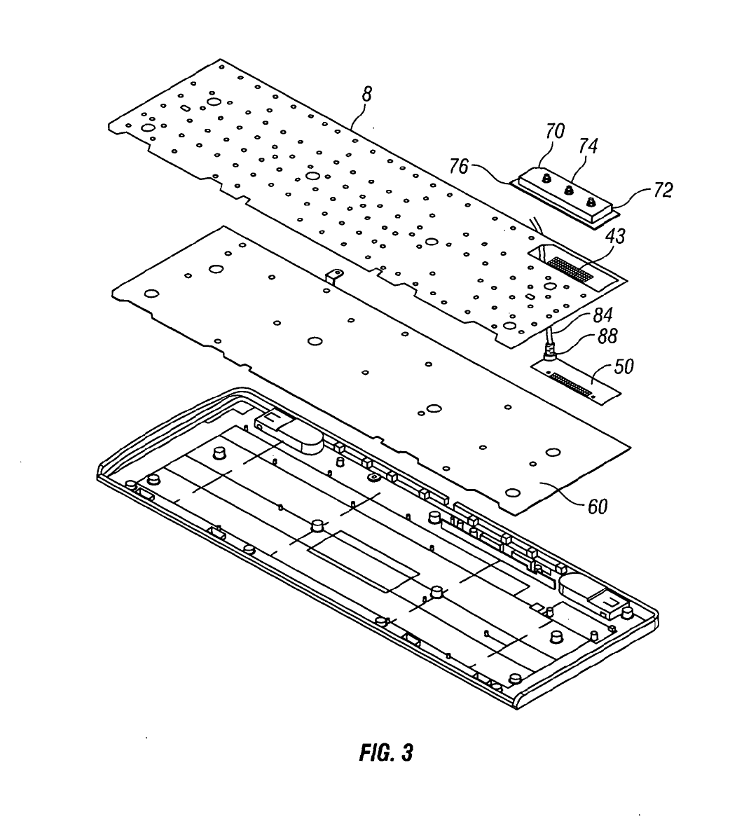

FIG. 3 shows an exploded view of the membrane assembly, support plate and keyboard base; and

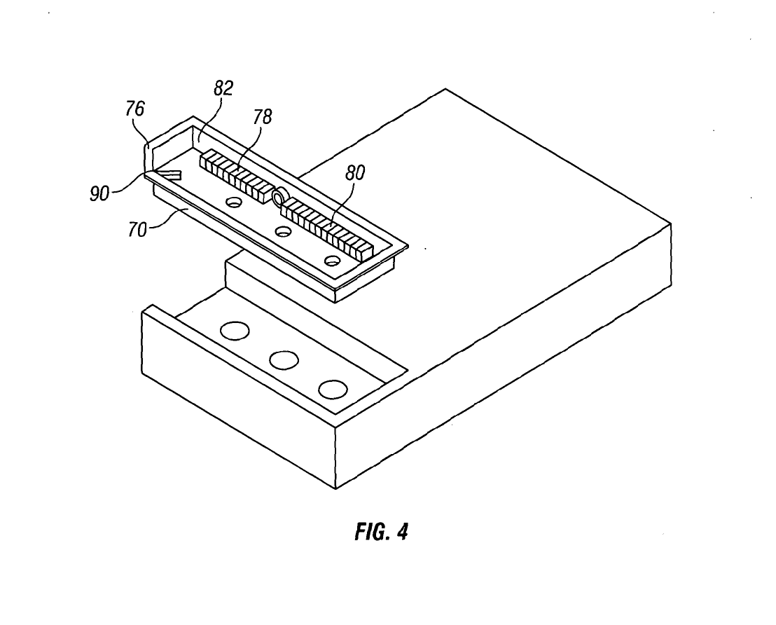

FIG. 4 shows a PCB housing according to an embodiment of the present invention.

Referring to FIG. 1, a computer keyboard 1 comprises an outer casing 2 including a keytop 4 and a base 6. Both the keytop 4 and base 6 are formed from moulded plastic and are preferably formed from a moulded polymeric material. The keytop 4 and base 6 include corresponding and opposing peripheral connection sections 4a and 6a which enable the two components to be connected together to form the outer casing 2.

The keytop 4 movably supports keypad 10 including multiple keys 12 arranged in a key matrix. An input assembly 8 is arranged beneath the keypad 10 for converting a mechanical input applied to the keypad 10 to an electrical input to a printed circuit board (PCB) to generate a command signal to be passed to a computer or similar device. The input assembly 8 comprises a grid of circuits arranged such that the circuits are broken at discrete points beneath each key. A processor monitors the key matrix for signs of continuity at any point on the grid. When it finds a circuit that is closed, it compares the location of that circuit on the key matrix to a character map in its ROM to determine the character to which the specific key corresponds.

The keypad 10 may include a plurality of rubber domes (not shown) located beneath each key 12. The rubber domes are arranged such that when the corresponding key 12 is pressed, a plunger in the bottom of the key 12 pushes down against the dome. This causes the rubber dome to push down also, until it presses against the input assembly 8 beneath the keypad 10. As long as the key 12 is held, a circuit on the input assembly 8 is completed at a discrete point corresponding in the character map to the specific key 12 depressed. When the key is released, the rubber dome springs back to its original shape, forcing the key back up to its rest position. Other key mechanism such as scissor mechanisms or buckling spring mechanisms may alternatively be utilized.

As shown in FIG. 2, the input assembly 8 comprises an upper membrane 20, a lower membrane 22, and a spacer membrane 24 arranged between the upper membrane 20 and the lower membrane 22. The upper membrane is formed from a flexible, non-conductive material such as polyethylene terephthalate (PET), and preferably a boPET such as Mylar (®). A circuit 26 is provided on the lower surface of the upper membrane 20. The circuit may be provided on the lower surface 30 by means of printing using an electrically conductive ink, or any other suitable means. The circuit 26 comprises a plurality of nodes corresponding to the key matrix of the keypad 12.

The lower membrane 22 is formed from the same material as the upper membrane 20. As shown in FIG. 2, the lower membrane 22 includes a circuit 36 on its upper surface 34 formed in the same manner as the circuit 26 of the upper membrane 20. The circuit 36 includes a plurality of nodes which positionally correspond to the nodes 28 of the upper membrane circuit 26.

The non-conductive spacer membrane 24 is positioned between the upper membrane 20 and the lower membrane 22, and is formed from the same material as the upper and lower membranes 20 and 22, although this is not essential and other non-conductive materials may be used. The spacer membrane 24 electrically isolates the upper circuit 26 from the lower circuit 36. A plurality of apertures 44 are formed in the spacer membrane 24 at locations corresponding to the nodes 28 and 38 of the upper and lower membrane 20 and 22. The size of the apertures 44 is selected such that nodes 28 and 38 of the upper circuit 26 and lower circuit 36 aligned with the apertures are held spaced apart. Specifically, the diameter of the apertures 44 is selected such that the depth of sag of the upper membrane 20 within the aperture 44 is less than the thickness of the spacer membrane 24. Preferably the thickness of each membrane is 100 micrometers, but the width of the apertures 26 may be varied for varying membranes thicknesses and hence varying sag coefficients.

The upper membrane includes a connection tab 40 comprising printed connection tracks connected to and extending from the circuit 26 of the upper membrane 20 for connecting the circuit 26 to a component such as a PCB 50. The printed electrical tracks of the connector tab 40 are provided on the same lower surface of the upper membrane 20 as the circuit 26 and are an extension thereof. Similarly the lower membrane 24 includes a connection tab 42 comprising printed connection tracks for connecting the lower circuit 36 to a component such as a PCB. The printed electrical tracks of the connector tab 42 are provided on the upper surface of the lower membrane 22 as the circuit 36 and are an extension thereof.

An aperture 51 is formed in each of the upper membrane 20, the lower membrane 22 and the spacer membrane 24, which align when the membranes and spacer membrane arc secured to each other to define an aperture extending entirely through the membrane assembly 8 defined by the upper 20, lower 22 and spacer 24 membranes. The connection tabs 40 and 42 each include a proximal base portion 47 which connects to the upper membrane 20 and lower membrane 22 respectively, and a distal portion 49 which extends into the aperture 51, with the distal end 49 being surrounded by a void defined by the aperture 51. The printed tracks of the upper connection tab 40 and are formed on the lower surface thereof such that they face downwardly when the membrane assembly is in its operational orientation away from the keyboard. The connection tracks of the lower connection tab 42 extend upwardly from the upper surface.

The printed electrical tracks of the upper 40 and lower 42 membrane align and the upper 40 and lower 42 tabs are secured to each other such that an electrical connection is formed between the tracks of each tab, with the connected tabs 40 and 42 defining a single connection tab 43. The upper 40 and lower 42 tabs may be adhered to each other by anisotropic adhesive film, or any other suitable means. The upper connection tab 40 is greater in length and extends further into the aperture 51 than the lower connection tab 42. As such, the upper connection tab 40 overhangs the lower connection tab 42 such that the tracks on the lower surface at the distal end 49 of the upper connection track 40 are exposed when the upper 40 and lower 42 tracks are connected to define a connection point for connection to the PCB.

The lower membrane 22 and spacer member 26 are of equal size, having an equal surface area and peripheral shape. The spacer member 24 is secured to the upper surface 34 of the lower membrane 22 by an adhesive applied at various point locations across the lower surface of the spacer membrane 24 selected to prevent interference with the printed circuit 34. The spacer membrane 24 and lower membrane 22 are similarly adhered to the lower surface 30 of the upper membrane 20 by a dotted adhesive. The lower membrane 22 may be sized such that its peripheral edge 43 extends past the peripheral edge 45 of the spacer member 24 to define a securing surface having adhesive applied thereto for adhering directly to the upper membrane 20.

The membrane assembly 8 is formed from the upper membrane 20, lower membrane 22 and spacer membrane 24. Each of the membranes 20 and 22 and the spacer member 24 is of a similar size. A sealing surface 54 on the lower surface of the upper membrane adheres the upper membrane to the spacer membrane 24. Similarly, a sealing surface 55 of the spacer membrane 24 secures the spacer membrane 24 to the lower membrane 22. The aperture 51 is located inwardly of the peripheral edges of the membranes and inwardly of the sealing surfaces. A further sealing surface is defined about the perimeter of the aperture 51 between the upper membrane 20 and the spacer membrane 24, and about the perimeter of the aperture 51 between the spacer membrane 24 and the lower membrane 22. In this way a sealed membrane assembly 8 is formed in which the circuits of the upper and lower membranes 20 and 22 are sealed and encapsulated, with the exception of the connection tab 43 defined by tabs 40 and 42, as shown in FIG. 3, which extends into and is exposed within the aperture 51.

A sealing surface 56 is defined about the periphery of the lower surface of the lower membrane 22. An adhesive is provided on the sealing surface 56, which adheres the membrane assembly 8 to a steel support plate 60. The steel support plate 60 is preferably substantially the same size as the membrane assembly 8.

The PCB locates beneath the tab 43 between the tab 43 and the steel support plate 60. The PCB comprises electrical connection tracks on its upper surface which align with and electrically connect to the corresponding exposed electrical tracks on the lower surface of the tab 43. To protect and waterproof the connection tab 43 and the PCB a cover 70 is provided. The cover 70 comprises an enclosure defined by a plurality of upstanding walls 72 and a top wall 74. A flange section or rib 76 extends outwardly from the lower edges of the walls 72. The enclosure 70 is hollow having an open base with an opening defined by the inner perimeter of the flange 76. The flange 76 is configured to be placed over the aperture 51 with the inner perimeter of the flange being substantially the same size and shape as the aperture 51 such that the lower surface of the flange 72 surrounds the aperture and seats against the upper surface of the upper membrane 20.

FIG. 4 shows an upturned view of the cover 70, which includes a plurality of internal ribs 78. The ribs 78 are integrally moulded as part of the cover 70 and extend downwardly from the inner surface of the top wall 74 contacting the top wall 74 along one edge and a side wall 72 along a second edge. The lower edges of the ribs 78, which as shown in FIG. 4 are upwardly facing but in use are downwardly facing, define a ledge 80. The aperture 51 and the opening defined by inner perimeter of the flange 76 and the walls 72 have substantially the same shape as the PCB 50 such that the PCB is closely received within the cover 70. The ribs are configured such that the ledge 80 is located at a distance spaced from the flange 76 substantially equal to the thickness of the PCB. In this way, when the PCB is received within the cover 70 it abuts the ledge 80 with its lower surface substantially flush with the lower surface of the flange 76.

The cover 70 further includes a series of internally located integrally moulded spigots 82. The spigots are interspaced with the ribs 78. The spigots 82 each include a threaded internal bore. The PCB includes a series of holes corresponding to the position of the spigots and configured to receive a series of screws. The screws extend through the PCB and into the spigots to enable the PCB 50 to be screwed to the cover 70. The connector tab 43 is located between the PCB and the cover 70. As the PCB is screwed to the cover 70, the tab 43 is clamped between the PCB 50 and the ledge 80 defined by the ribs 78. This clamping engagement urges the PCB 50 and the tab 43 into engagement and secure electrical connection therebetween.

A portion of the side wall 72 is configured to receive a connection cable 84 for the PCB 50. The connection cable 84 is received through an aperture in the side wall 72 of the cover 70. The cable 84 includes an electrical connector 86 at its free end for connection to the

PCB 50. A grommet 88 is moulded about the connection cable 84 proximate the connector 86. The grommet 88 is received by and seals against the aperture in the cover 70 to seal the connector 86 within the cover 70. Additional ribs 90 are formed within the cover 70. The ribs 90 receive the connector 86 and position it such that it aligns with the corresponding connector of the PCB 50 is screwed to the cover 70.

With the PCB 50 screwed to and enclosed but not encompassed within the open based cover, such that the cover 70 also encloses the tab 43 and connector 86, the lower surface of the flange 76 is adhered to the portion of the upper surface of the upper membrane 20 surrounding the aperture 51. The upper membrane 20 and the cover 70 combine to form a continuous upper layer which covers and seals the PCB 50 from above. The PCB 50 is sealed from below between the steel support plate 60 and the lower membrane assembly 8 through the seal between the lower membrane 22 and the steel plate 60. The input assembly defined by the combination of the membrane assembly 8 and the steel support plate defines a stand alone sealed input unit, with the input circuits and PCB sealed within a single unit which may be installed into any keyboard assembly without requirement for additional sealing, with an external connection from the PCB 50 being provided in a sealed manner.

For final assembly of the keyboard 1, the laminated input assembly 8 is adhered to the base 2. Adhesive is applied around the entire periphery of the base of the support plate 60 to secure and seal the plate 60 to the base 2. As such, components exposed or extending through the base of the support plate 60 are sealed between the peripheral edge of the support plate 60 and the base 2. In this way, components may be externally connected to the input assembly 8 upwards through the base 2, with the connections to the input assembly remaining watertight by sealing the surface of the component including the exposed electrical connections to the base 2, such as a memory card reader.

In an alternative embodiment the upper membrane 20 may be formed to have a larger surface area defining a larger footprint than the lower membrane 22 and the spacer member 26. The peripheral edge 52 of the upper membrane 20 extends past the peripheral edges of the lower membrane 22 and spacer membrane 24 to form an overhanging fringe section, the lower surface of which defines a sealing surface 54 around the periphery of the upper membrane.

The sealing surface 54 is positioned outwardly of the circuit 26 of the upper membrane 20, and outwardly of the connection tracks 40. Similarly, when placed over the lower membrane 22, the sealing surface 54 is positioned outwardly of the circuit 34 of the lower membrane 22, and outwardly of the connection tracks 42 and 43. The sealing surface 54 of the upper membrane 20 seals directly against the steel support plate 60 to seal and encapsulate the spacer membrane 24 and lower membrane 22.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

It will be appreciated that in further embodiments various modifications to the specific arrangements described above and shown in the drawings may be made. For example, it is noted that the terms upper and lower are used to describe the arrangement of the membrane layers relative to a further surface, with upper meaning uppermost or furthest spaced from the further surface. These terms are not intended to be limiting and do not refer to any specific orientation, and for example in use the upper layer may be positioned below the lower in terms of the absolute vertical positions of the membranes, while still being above the lower layer in terms of the further layer to which they are secured. Similarly the terms upper layer and lower surfaces refer to the direction in which the surfaces face relative to the further layer, with the upper surface facing away from the further surface. Furthermore, while the input assembly is described for use with a computer keyboard, it could be used in connection with any device requiring conversion of a manual point input from a user to a corresponding electrical signal, for example in the control pad of an ATM machine, or other external interfaces requiring user input. It will also be appreciated that the support member 60 may be any further surface to which the membrane assembly is secured, and includes but is not limited to planar members. For example it is conceived that the membrane assembly could conform and be sealed to uneven or ergonomically shaped surfaces.

1. An input assembly for a human interface device comprising:
a first membrane having an electrical circuit provided on a surface thereof;
a second membrane having an electrical circuit provided on a surface thereof, the first and second membranes being arranged such that the electrical circuits of each membrane are facing each other;
a spacer member between the first and second membranes configured to permit a selective electrical connection between the electrical circuits of the first and second membranes;
an electrical circuit board connected to the electrical circuits of the first and second membranes inwardly of peripheral outer edges of both the first and second membranes; and
a housing for enclosing and sealing the electrical circuit board;
wherein the housing comprises an opening configured to receive the electrical circuit board, the edge of the opening defining an opening perimeter sealed to the first membrane to seal and enclose the electrical circuit board.

2. The input assembly according to claim 1, the first and second membranes each including an electrical connection portion located inwardly of the outer edge of each membrane and aligned and connected to each other through an aperture in the spacer member, the electrical connection portions located between the electrical circuit board and a portion of the housing such that the electrical connection portions are clamped between the electrical circuit board and the housing in electrical connection with the electrical circuit board.

3. The input assembly according to claim 2 further comprising a base member, the second membrane including a sealing portion defined about one or more edges of the second membrane, the sealing portion sealed to the base member such that the electrical connection portions and electrical circuit board are sealed from above by the housing and from below through a sealed connection between the second membrane and the base.

4. The input assembly according to claim 3 wherein one or more edges of inner surfaces of the first and second membranes are sealed to one or more of the spacer member and each other.

5. The input assembly according to claim 3, the housing including a plurality of internal ribs defining a clamping surface against which the electrical connection portions of the first and second membranes are clamped by the electrical circuit board.

6. The input assembly according to claim 5, the housing including at least one internal connection portion comprising a threaded bore configured to receive a corresponding screw to secure the electrical circuit board to the housing, the at least one internal connection portion being arranged such that when the electrical circuit board is screwed thereto the electrical circuit board is urged into clamping engagement with the ribs of the housing to clamp the electrical connection portions between the electrical circuit board and the ribs of the housing.

7. The input assembly according to claim 1, the housing comprising a flange section extending around and defining the opening, the flange section comprising a sealing surface adhered to the first membrane to seal the housing to the first membrane.

8. The input assembly according to claim 1, the housing comprising a connection aperture configured to receive a connection cable for external electrical connection to the electrical circuit board₂ and the input assembly further comprising a sealing member between the cable and the portion of the housing defining the aperture.

9. (canceled)

10. An input assembly for a keyboard comprising:
a first membrane having an electrical circuit provided on a surface thereof;
a second membrane having an electrical circuit provided on a surface thereof, the first and second membranes being arranged such that the electrical circuits of each membrane are facing each other;
a spacer member between the first and second membranes configured to permit a selective electrical connection between the electrical circuits of the first and second membranes;
an electrical circuit board connected to the electrical circuits of the first and second membranes inwardly of outer edges of both the first and second membranes; and
a housing for enclosing and sealing the electrical circuit board;
wherein the housing comprises an opening configured to receive the electrical circuit board, the edge of the opening defining an opening perimeter sealed to the first membrane to seal and enclose the electrical circuit board.

11. The input assembly according to claim 10, the first and second membranes each including an electrical connection portion located inwardly of the outer edge of each membrane and aligned and connected to each other through an aperture in the spacer member, the electrical connection portions located between the electrical circuit board and a portion of the housing such that the electrical connection portions are clamped between the electrical circuit board and the housing in electrical connection with the electrical circuit board.

12. The input assembly according to claim 11 further comprising a base member, the second membrane including a sealing portion defined about one or more edges of the second membrane, the sealing portion sealed to the base member such that the electrical connection portions and electrical circuit board are sealed from above by the housing and from below through a sealed connection between the second membrane and the base.

13. The input assembly according to claim 12 wherein one or more edges of inner surfaces of the first and second membranes are sealed to one or more of the spacer member and each other.

14. The input assembly according to claim 12, the housing including a plurality of internal ribs defining a clamping surface against which the electrical connection portions of the first and second membranes are clamped by the electrical circuit board.

15. The input assembly according to claim 14, the housing including at least one internal connection portion comprising a threaded bore configured to receive a corresponding screw to secure the electrical circuit board to the housing, the at least one internal connection portion being arranged such that when the electrical circuit board is screwed thereto the electrical circuit board is urged into clamping engagement with the ribs of the housing to clamp the electrical connection portions between the electrical circuit board and the ribs of the housing.

16. The input assembly according claim 10, the housing comprising a flange section extending around and defining the opening, the flange section comprising a sealing surface adhered to the first membrane to seal the housing to the first membrane.

17. The input assembly according to claim 10, the housing comprising a connection aperture configured to receive a connection cable for external electrical connection to the electrical circuit board, and input assembly further comprising a sealing member between the cable and the portion of the housing defining the aperture.
